(19) United States
(12) Patent Application Publication
(10) Pub. No.: US 2025/0293585 A1
(43) Pub. Date: Sep. 18, 2025

(54) GRID-FORMING CONTROL METHOD FOR POWER CONVERTER AND POWER CONVERTER

(71) Applicant: Huawei Digital Power Technologies Co., Ltd., Shenzhen (CN)

(72) Inventors: Mingquan ZHAO, Shanghai (CN); Kai XIN, Shanghai (CN); Yunfeng LIU, Shanghai (CN); Fei XU, Shenzhen (CN); Zisen QU, Shenzhen (CN)

(73) Assignee: Huawei Digital Power Technologies Co., Ltd., Shenzhen (CN)

(21) Appl. No.: 19/224,998

(22) Filed: Jun. 2, 2025

Related U.S. Application Data
(63) Continuation of application No. PCT/CN2023/134802, filed on Nov. 28, 2023.

(30) Foreign Application Priority Data
Dec. 9, 2022 (CN) 202211582365.0

(51) Int. Cl. H02M 1/12; H02M 7/44

(52) U.S. Cl. CPC H02M 1/123; H02M 7/44

(57) ABSTRACT

A grid-forming control method for a power converter and a power converter. The power converter includes a conversion circuit, an input end of the conversion circuit is connected to a direct current source, an output end is connected to an electric power system. The power converter detects an output voltage of the conversion circuit, and when an amplitude of the output voltage exceeds a specified voltage range, controls the conversion circuit to output a first reactive power. The conversion circuit quickly supports a voltage of the electric power system by changing a manner of outputting a reactive power. The power converter calculates the reactive power based on an upper-limit voltage or a lower-limit voltage of the specified voltage range, and maximally supports the voltage of the electric power system, so that the electric power system operates within a normal voltage range.

### CROSS-REFERENCE TO RELATED APPLICATIONS

This application is a continuation of International Application No. PCT/CN2023/134802, filed on Nov. 28, 2023, which claims priority to Chinese Patent Application No. 202211582365.0, filed on Dec. 9, 2022. The disclosures of the aforementioned applications are hereby incorporated by reference in their entireties.

### TECHNICAL FIELD

The embodiments relate to the field of power electronics technologies, and to a grid-forming control method for a power converter and a power converter.

### BACKGROUND

In recent years, global temperature has been rising, making peak carbon emissions and carbon neutrality core tasks of important countries in the world to cope with climate change. To reduce carbon emissions, wide application of new energy and energy storage devices becomes a future development trend. Generally, energy in the new energy and energy storage devices cannot be directly used, and needs to be converted into electric energy for use by human. For example, a photovoltaic power generation system converts solar energy into electric energy, and a wind power generation system converts wind energy into electric energy.

In a process of constructing a new electric power system based on new energy, the new energy is a supply source of the electric power system, and coal power is downgraded to auxiliary energy. The new electric power system in the future is a system including a large proportion of power electronic devices. However, the new energy power electronic device of the new electric power system has strong fluctuation and weak support. Consequently, a voltage of the electric power system is likely to fluctuate, and safety and reliability of operation of the electric power system are greatly affected.

### SUMMARY

To resolve the foregoing problem, embodiments provide a grid-forming control method for a power converter and a power converter. When a voltage of an electric power system fluctuates, the power converter can quickly support the voltage of the electric power system, and can maximally support the voltage of the electric power system, so that the power converter can operate within a normal voltage range. The power converter seamlessly switches between a voltage control mode and a reactive power control mode through contention, without affecting the electric power system.

Therefore, the following solutions are used in embodiments.

According to a first aspect, an embodiment provides a grid-forming control method for a power converter, used in the power converter. The power converter includes a conversion circuit, an input end of the conversion circuit is configured to connect to a direct current source, an output end of the conversion circuit is configured to connect to an electric power system, and the method includes: detecting an output voltage at the output end of the conversion circuit; and when an amplitude of the output voltage is greater than an upper-limit voltage of a specified voltage range or less than a lower-limit voltage of the specified voltage range, controlling the conversion circuit to output a first reactive power. The upper-limit voltage is a maximum voltage value within the specified voltage range, the lower-limit voltage is a minimum voltage value within the specified voltage range, and the first reactive power is a reactive power that enables the amplitude of the output voltage at the output end of the conversion circuit to be within the specified voltage range.

In this implementation, after determining that the amplitude of the output voltage at the output end of the conversion circuit exceeds the specified voltage range, the power converter may control the conversion circuit to output the corresponding reactive power based on the specified voltage range. The power converter quickly supports a voltage of the electric power system in a reactive power manner. In addition, the power converter calculates the reactive power based on the upper-limit voltage or the lower-limit voltage of the specified voltage range, and maximally supports the voltage of the electric power system, so that the electric power system can operate within a normal voltage range.

In an implementation, when the amplitude of the output voltage is greater than the upper-limit voltage of the specified voltage range or less than the lower-limit voltage of the specified voltage range, the controlling the conversion circuit to output a first reactive power includes: calculating an upper-limit reactive power based on the upper-limit voltage, and calculating a lower-limit reactive power based on the lower-limit voltage; selecting a contention reactive power based on a relationship between the upper-limit reactive power, the lower-limit reactive power, and an upper-level scheduled reactive power, where the contention reactive power is one of the upper-limit reactive power, the lower-limit reactive power, and the upper-level scheduled reactive power; and controlling, based on the contention reactive power, the conversion circuit to output the first reactive power.

In this implementation, the power converter enables the upper-limit reactive power or the lower-limit reactive power to contend with the upper-level scheduled reactive power, and outputs the contention reactive power. The power converter seamlessly switches between a voltage control mode and a reactive power control mode through contention, without affecting the electric power system.

In an implementation, the calculating an upper-limit reactive power based on the upper-limit voltage includes: when the amplitude of the output voltage is greater than the upper-limit voltage, calculating a second reactive power based on the upper-limit voltage; and limiting an amplitude of a voltage corresponding to the second reactive power, and calculating the upper-limit reactive power.

In this implementation, when determining that the voltage of the electric power system is greater than the upper-limit voltage of the specified voltage range, the power converter may calculate, based on the upper-limit voltage, the reactive power that supports the stable voltage of the electric power system. In this way, the power converter supports the voltage of the electric power system by outputting the reactive power.

In an implementation, the calculating a lower-limit reactive power based on the lower-limit voltage includes: when the amplitude of the output voltage is less than the lower-limit voltage, calculating a third reactive power based on the lower-limit voltage; and limiting an amplitude of a voltage corresponding to the third reactive power, and calculating the lower-limit reactive power.

In this implementation, when determining that the voltage of the electric power system is less than the lower-limit voltage of the specified voltage range, the power converter may calculate, based on the lower-limit voltage, the reactive power that supports the stable voltage of the electric power system. In this way, the power converter supports the voltage of the electric power system by outputting the reactive power.

In an implementation, the selecting a contention reactive power based on a relationship between the upper-limit reactive power, the lower-limit reactive power, and an upper-level scheduled reactive power includes: selecting a smaller reactive power from the upper-limit reactive power and the upper-level scheduled reactive power as an upper-limit contention reactive power; and selecting a larger reactive power from the upper-limit contention reactive power and the lower-limit reactive power as the contention reactive power.

In an implementation, the selecting a contention reactive power based on a relationship between the upper-limit reactive power, the lower-limit reactive power, and an upper-level scheduled reactive power includes: selecting a larger reactive power from the lower-limit reactive power and the upper-level scheduled reactive power as a lower-limit contention reactive power; and selecting a smaller reactive power from the lower-limit contention reactive power and the upper-limit reactive power as the contention reactive power.

In an implementation, the method further includes: when the amplitude of the output voltage is within the specified voltage range, controlling the conversion circuit to output the upper-level scheduled reactive power.

In this implementation, when the power converter determines that the voltage of the electric power system exceeds the specified voltage range, it indicates that the voltage of the electric power system fluctuates greatly. The power converter performs a voltage control function, and outputs the reactive power to the electric power system to support the voltage.

In an implementation, the method further includes: when time in which the amplitude of the output voltage of the conversion circuit is at the upper-limit voltage or the lower-limit voltage exceeds first specified time, maintaining a value of the contention reactive power unchanged.

In this implementation, when it is determined that the time in which the amplitude of the output voltage is stable at the upper-limit voltage or the lower-limit voltage exceeds the first specified time, the power converter may freeze the output contention reactive power. In this way, the electric power system maintains stable operation. In addition, the power converter can avoid a cross current between a plurality of power converters due to voltage control.

In an implementation, the method further includes: when time in which the amplitude of the output voltage of the conversion circuit is at the upper-limit voltage or the lower-limit voltage exceeds second specified time, controlling the conversion circuit to output the upper-level scheduled reactive power, or controlling the conversion circuit to output another reactive power according to a preset function. The second specified time is greater than the first specified time.

In this implementation, after the time in which the power converter outputs the voltage to support the electric power system exceeds the second specified time, the power converter does not enter the voltage control mode, and outputs the upper-level scheduled reactive power or the reactive power generated according to the preset function. This can avoid that a reactive power requirement of the electric power system is borne by a few power converters, resulting in a decrease in reliability of the power converters.

In an implementation, before the calculating an upper-limit reactive power based on the upper-limit voltage, and calculating a lower-limit reactive power based on the lower-limit voltage, the method further includes: detecting an output current at the output end of the conversion circuit; and when the output current is greater than a specified current threshold, obtaining a dynamic virtual impedance and a dynamic virtual impedance according to a preset function.

In this implementation, when great disturbance occurs in the voltage of the electric power system, the output current at the output end of the conversion circuit may be saturated. Consequently, control of the power converter is unstable. After the disturbance occurs in the electric power system, the power converter inputs the dynamic virtual impedance, to avoid the saturation of the power converter.

In an implementation, the controlling, based on the contention reactive power, the conversion circuit to output the first reactive power includes: controlling an amplitude of an inner potential based on the contention reactive power, where the amplitude of the inner potential is an amplitude of a voltage of an inner potential vector output by the power converter to support the voltage of the electric power system; and controlling a voltage of the inner potential of the power converter based on the amplitude of the inner potential, a phase of the inner potential, and a frequency of the inner potential, to enable the conversion circuit to output the first reactive power.

According to a second aspect, an embodiment provides a power converter, including a conversion circuit and a controller. An input end of the conversion circuit is configured to connect a direct current source, and an output end of the conversion circuit is configured to connect an electric power system. The power converter is configured to convert direct current electric energy into alternating current electric energy under control of the control apparatus. The controller is configured to: obtain an output voltage at the output end of the conversion circuit; and when an amplitude of the output voltage is greater than an upper-limit voltage of a specified voltage range or less than a lower-limit voltage of the specified voltage range, control the conversion circuit to output a first reactive power. The upper-limit voltage is a maximum voltage value within the specified voltage range, the lower-limit voltage is a minimum voltage value within the specified voltage range, and the first reactive power is a reactive power that enables the amplitude of the output voltage at the output end of the conversion circuit to be within the specified voltage range.

In an implementation, the controller is configured to: calculate an upper-limit reactive power based on the upper-limit voltage, and calculate a lower-limit reactive power based on the lower-limit voltage; select a contention reactive power based on a relationship between the upper-limit reactive power, the lower-limit reactive power, and an upper-level scheduled reactive power, where the contention reactive power is one of the upper-limit reactive power, the lower-limit reactive power, and the upper-level scheduled reactive power; and control, based on the contention reactive power, the conversion circuit to output the first reactive power.

In an implementation, that the controller calculates an upper-limit reactive power based on the upper-limit voltage includes: when the amplitude of the output voltage is greater than the upper-limit voltage, calculating a second reactive power based on the upper-limit voltage; and limiting an amplitude of a voltage corresponding to the second reactive power, and calculating the upper-limit reactive power.

In an implementation, that the controller calculates a lower-limit reactive power based on the lower-limit voltage includes: when the amplitude of the output voltage is less than the lower-limit voltage, calculating a third reactive power based on the lower-limit voltage; and limiting an amplitude of a voltage corresponding to the third reactive power, and calculating the lower-limit reactive power.

In an implementation, that the controller selects a contention reactive power based on a relationship between the upper-limit reactive power, the lower-limit reactive power, and an upper-level scheduled reactive power includes: selecting a smaller reactive power from the upper-limit reactive power and the upper-level scheduled reactive power as an upper-limit contention reactive power; and selecting a larger reactive power from the upper-limit contention reactive power and the lower-limit reactive power as the contention reactive power.

In an implementation, that the controller selects a contention reactive power based on a relationship between the upper-limit reactive power, the lower-limit reactive power, and an upper-level scheduled reactive power includes: selecting a larger reactive power from the lower-limit reactive power and the upper-level scheduled reactive power as a lower-limit contention reactive power; and selecting a smaller reactive power from the lower-limit contention reactive power and the upper-limit reactive power as the contention reactive power.

In an implementation, the controller is further configured to: when the amplitude of the output voltage is within the specified voltage range, control the conversion circuit to output the upper-level scheduled reactive power.

In an implementation, the controller is further configured to: when time in which the amplitude of the output voltage of the conversion circuit is at the upper-limit voltage or the lower-limit voltage exceeds first specified time, maintain a value of the contention reactive power unchanged.

In an implementation, the controller is further configured to: when time in which the amplitude of the output voltage of the conversion circuit is at the upper-limit voltage or the lower-limit voltage exceeds second specified time, control the conversion circuit to output the upper-level scheduled reactive power, or control the conversion circuit to output another reactive power according to a preset function. The second specified time is greater than the first specified time.

In an implementation, the controller is further configured to: detect an output current at the output end of the conversion circuit; and when the output current is greater than a specified current threshold, obtain a dynamic virtual impedance and a dynamic virtual impedance according to a preset function.

In an implementation, that the controller controls, based on the contention reactive power, the conversion circuit to output the first reactive power includes: controlling an amplitude of an inner potential based on the contention reactive power, where the amplitude of the inner potential is an amplitude of a voltage of an inner potential vector output by the power converter to support a voltage of the electric power system; and controlling a voltage of the inner potential of the power converter based on the amplitude of the inner potential, a phase of the inner potential, and a frequency of the inner potential, to enable the conversion circuit to output the first reactive power.

According to a third aspect, an embodiment provides a grid-tied electric power system, including a new energy component and/or an energy storage system, and at least one power converter according to the possible implementations of the second aspect. An input end of the power converter is connected to the new energy component and/or the energy storage system, an output end of the power converter is configured to connect to the electric power system, and the converter is configured to convert a direct current of the new energy component and/or the energy storage system into an alternating current of the electric power system.

According to a fourth aspect, an embodiment provides a non-transitory computer-readable storage medium. The non-transitory computer-readable storage medium stores a computer program. When the computer program is executed in a computer, the computer is enabled to perform the possible implementations of the first aspect.

According to a fifth aspect, an embodiment provides a computer program product. The computer program product stores instructions, and when the instructions are executed by a computer, the computer is enabled to implement the possible implementations of the first aspect.

### BRIEF DESCRIPTION OF DRAWINGS

The following briefly describes the accompanying drawings used in descriptions of embodiments or the conventional technology.

FIG. 1 is a diagram of an architecture of a grid-tied electric power system according to an embodiment;

FIG. 2 is a diagram of an architecture of a power converter according to an embodiment;

FIG. 3 is a diagram of an architecture of a controller according to an embodiment;

FIG. 4 is a diagram of a control objective and control effect of a controller according to an embodiment;

FIG. 5 is a diagram of a control objective and control effect of a controller according to an embodiment;

FIG. 6 is a diagram of a control objective and control effect of a controller according to an embodiment; and

FIG. 7 is a schematic flowchart of a grid-forming control method for a power converter according to an embodiment.

### DETAILED DESCRIPTION OF EMBODIMENTS

The following describes the solutions in embodiments with reference to the

accompanying drawings.

In descriptions of the embodiments, orientations or location relationships indicated by terms “center”, “upper”, “lower”, “front”, “rear”, “left”, “right”, “vertical”, “horizontal”, “top”, “bottom”, “inner”, “outer”, and the like are based on orientations or location relationships shown in the accompanying drawings, and are merely intended for ease of describing this application and simplifying descriptions, instead of indicating or implying that a specified apparatus or element needs to have a specific orientation, and be constructed and operated in the specific orientation. Therefore, such language cannot be understood as a limitation on the embodiments.

In descriptions of the embodiments, it should be noted that unless otherwise expressly specified and limited, terms “mount”, “interconnect”, and “connect” should be understood in a broad sense. For example, such terms may indicate a fixed connection, a detachable connection, an abutting connection, or an integral connection. Persons of ordinary skill in the art may understand specific meanings of the foregoing terms in the embodiments based on specific cases.

In the descriptions of the embodiments, the term “and/or” describes an association relationship between associated objects and represents that three relationships may exist. For example, A and/or B may represent the following three cases: only A exists, both A and B exist, and only B exists. The character “/” indicates an “or” relationship between the associated objects. For example, A/B indicates A or B.

In the descriptions of the embodiments, the terms “first”, “second”, and the like are intended to distinguish between different objects but do not indicate a particular order of the objects. For example, a first response message, a second response message, and the like are used for distinguishing between different response messages, but are not used for describing a particular order of the response messages.

In descriptions of the embodiments, a word like “in an embodiment” or “for example” is used for representing an example, an example illustration, or description. Any embodiment or design solution described as “in an embodiment” or “for example” in embodiments is not to be construed as being more preferred or having more advantages than another embodiment or design solution. Exactly, use of the word like “in an embodiment” or “for example” is intended to present a related concept in a specific manner.

In the descriptions of the embodiments, specific features, structures, materials, or characteristics may be combined in a proper manner in any one or more embodiments or examples.

In a conventional electric power system, synchronous generators are connected in parallel at several main nodes of the electric power system. The synchronous generator can support a voltage of the electric power system, so that the electric power system can operate stably. In a new electric power system, a new energy power generation system gradually replaces the synchronous generator, and this becomes an irreversible trend. However, the new energy power generation system also has a large limitation. For example, a voltage support capability is limited. As a result, the new energy power generation system cannot completely replace the synchronous generator in terms of grid connection characteristics.

If a power electronic device replaces the synchronous generator, the power electronic device needs to have a capability, of supporting the electric power system, that matches the synchronous generator to ensure the stable operation of the new electric power system. In comparison with the synchronous generator, the power electronic device has a weaker overcurrent capability. However, the power electronic device also has advantages such as a fast response speed, flexible control, and a low price. The power electronic device can match the capability, of supporting the electric power system, of the synchronous generator by optimizing a control algorithm.

Kernels of conventional grid-following and grid-forming algorithms are controlling an output current. The power electronic device may provide power support for the electric power system in response to dynamics of the electric power system. However, the power electronic device needs to perform steps such as detecting the dynamics of the electric power system, delivering an instruction, and executing an instruction, to implement a function of supporting the electric power system.

A grid-forming technology is an extremely potential grid-tied algorithm technology that is currently used to enable an electric power system including an ultra-high proportion of power electronic devices to operate stably. The grid-forming technology naturally has a capability of supporting the electric power system in terms of a control manner. A kernel of a grid-forming algorithm is controlling an output voltage. When disturbance occurs in a voltage of the electric power system, an inner potential of a converter remains unchanged instantaneously, so that the converter can naturally have the capability of supporting the electric power system. However, the power electronic device has a weak overcurrent capability. If the power electronic device is not controlled and optimized, the power electronic device is quickly protected, so that the power electronic device cannot support the voltage of the electric power system. Therefore, a control algorithm of the power electronic device needs to be optimized to improve the capability of supporting the voltage of the electric power system.

To resolve a problem that the existing power electronic device has insufficient capability of supporting the voltage of the electric power system, embodiments provide a grid-tied electric power system, a power converter, and a grid-forming control method for the power converter.

FIG. 1 is a diagram of an architecture of a grid-tied electric power system according to an embodiment. As shown in FIG. 1, the grid-tied electric power system 10 includes an electric power system 100, at least one power converter 200, and at least one external power system 300. The at least one external power system 300 is coupled to the electric power system 100 via the at least one power converter 200.

The electric power system 100 may be a national electric power system, a home power grid, an enterprise power grid, or another alternating current electric power system. This is not limited.

The power converter 200 may be an inverter, a converter, a modular multilevel converter, or another power converter. This is not limited.

The external power system 300 may be a new energy system, for example, a photovoltaic power generation system, a wind power generation system, or another direct current electric power system. The new energy system includes new energy components such as a photovoltaic module and a windmill. The external power system 300 may be an energy storage system like a backup battery. This is not limited.

In the embodiments, the external power system 300 is connected in parallel to several main nodes of the electric power system 100 via the power converter 200, to support a voltage of the electric power system 100, thereby implementing stable operation of the electric power system 100.

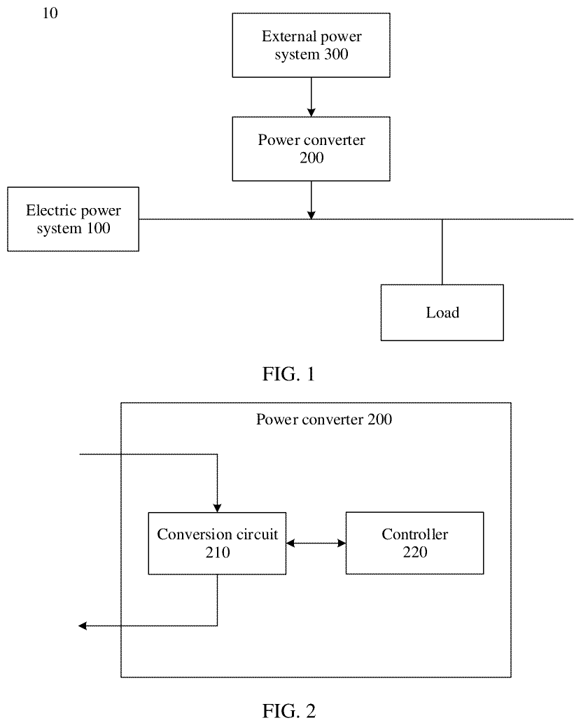

FIG. 2 is a diagram of an architecture of a power converter according to an embodiment. As shown in FIG. 2, the power converter 200 includes a conversion circuit 210 and a controller 220. One end of the conversion circuit 210 is electrically connected to the electric power system 100. The other end of the conversion circuit 210 is electrically connected to the external power system 300.

The conversion circuit 210 includes a bidirectional direct current/alternating current (DC/AC) converter. The bidirectional DC/AC converter may convert an alternating current into a direct current, or convert a direct current into an alternating current. In this application, a current of the external power system 300 is a direct current. A current of the electric power system 100 is an alternating current. The conversion circuit 210 converts the direct current of the external power system 300 into an alternating current with a specified voltage value, and inputs the alternating current to the electric power system 100, to support the voltage of the electric power system 100. In another embodiment, the conversion circuit 210 may be another type of circuit, for example, an inverter circuit or a rectifier circuit. This is not limited.

The controller 220 may be a digital signal processing (DSP) unit, a field programmable gate array (FPGA), a microcontroller unit (MCU), or another device having a calculation and control function. In this application, the controller 220 is coupled to the conversion circuit 210, and is configured to receive an amplitude of an output voltage at an output end of the conversion circuit 210. When the amplitude of the output voltage is greater than an upper-limit voltage of a specified voltage range or less than a lower-limit voltage of the specified voltage range, the conversion circuit 210 is controlled to output a first reactive power. The power converter 200 outputs the first reactive power to the electric power system 100, so that the external power system 300 supports the voltage of the electric power system 100, thereby implementing stable operation of the electric power system 100.

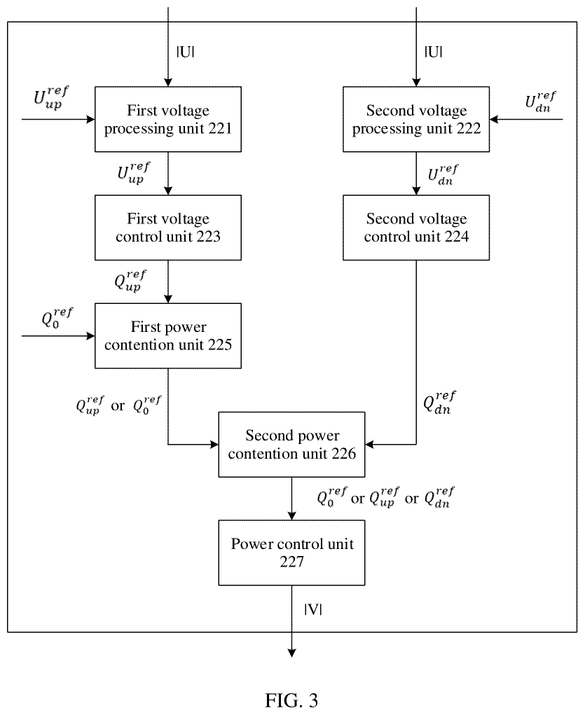

As shown in FIG. 3, the controller 220 may be divided into a first voltage processing unit 221, a second voltage processing unit 222, a first voltage control unit 223, a second voltage control unit 224, a first power contention unit 225, a second power contention unit 226, and a power control unit 227 based on executed functions. The first voltage processing unit 221, the second voltage processing unit 222, the first voltage control unit 223, the second voltage control unit 224, the first power contention unit 225, the second power contention unit 226, and the power control unit 227 may all be implemented by software, or may be implemented by hardware, or may be implemented by a combination of software and hardware.

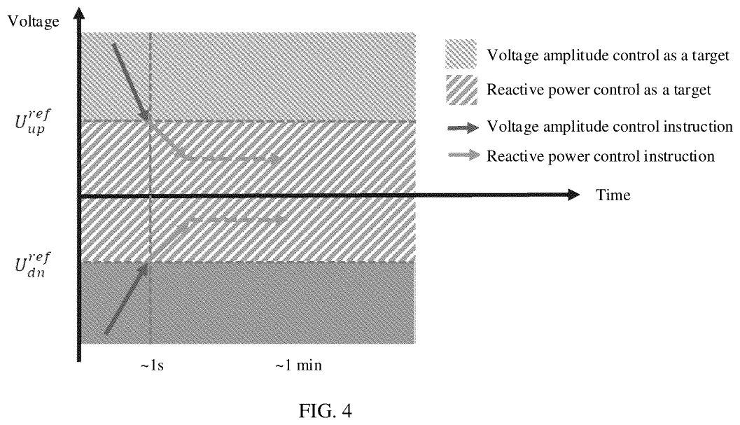

The following describes the solutions of the embodiments by using the execution units of the controller 220 and with reference to a diagram of a control objective and control effect shown in FIG. 4.

The first voltage processing unit 221 is configured to receive the amplitude |U| of the output voltage at the output end of the conversion circuit 210 and an upper-limit voltage Uᵤₚ^{ref} stored in the controller 220. The first voltage processing unit 221 may determine a numerical relationship between the amplitude |U| of the output voltage and the upper-limit voltage Uᵤₚ^{ref} based on the amplitude |U| of the output voltage and the upper-limit voltage Uᵤₚ^{ref}. The upper-limit voltage Uᵤₚ^{ref} is a maximum voltage value that does not affect normal operation of a load when the voltage of the electric power system 100 fluctuates.

The second voltage processing unit 222 is configured to receive the amplitude |U| of the output voltage at the output end of the conversion circuit 210 and a lower-limit voltage U_{dn}^{ref} stored in the controller 220. The second voltage processing unit 222 determines a numerical relationship between the amplitude |U| of the output voltage and the lower-limit voltage U_{dn}^{ref} based on the amplitude |U| of the output voltage and the lower-limit voltage U_{dn}^{ref}. The lower-limit voltage U_{dn}^{ref} is a minimum voltage value that does not affect normal operation of the load when the voltage of the electric power system 100 fluctuates.

In an embodiment, when the amplitude |U| of the output voltage is not greater than the upper-limit voltage Uᵤₚ^{ref} and is not less than the lower-limit voltage U_{dn}^{ref}, it indicates that an amplitude of the voltage of the electric power system 100 is within a normal voltage range. In this case, a voltage fluctuation of the electric power system 100 is small, and the power converter 200 may not need to additionally modify the reactive power output by the device, and preferentially perform a reactive power control function. The controller 220 may send an original reactive power Q₀^{ref} to the power control unit 227.

When the power converter 200 provides voltage support for the electric power system 100, the power converter 200 can output an active power Pe and a reactive power Qe to the electric power system 100. The active power Pe refers to alternating-current energy actually emitted or consumed per unit time. The reactive power Qe means that in an alternating current circuit with reactance, an electric field or a magnetic field absorbs energy from a power supply in a part of a period, and releases the energy in another part of the period. An average power in the entire period is zero, but the energy is constantly exchanged between the power supply and reactance elements (a capacitor and an inductor). A maximum exchange rate is the reactive power Qe. The active power Pe output by the power converter 200 can stabilize the voltage of the electric power system 100 within the specified range, and enable the load electrically connected to the electric power system 100 to operate normally. The reactive power Qe output by the power converter 200 can support the amplitude of the voltage of the electric power system 100, to implement reactive overvoltage support.

The original reactive power Q₀^{ref} is an original reactive power instruction sent by an upper-level scheduling center like a power plant or a power grid company, so that the power converter 200 outputs the required reactive power to the electric power system 100.

In an embodiment, when the amplitude |U| of the output voltage is greater than the upper-limit voltage Uᵤₚ^{ref}, it indicates that the amplitude of the voltage of the electric power system 100 exceeds the normal voltage range. In this case, the amplitude of the voltage of the electric power system 100 operates at a high abnormal operating level, and the power converter 200 needs to additionally modify the reactive power output by the device, to support the voltage of the electric power system 100. The first voltage processing unit 221 may enable the power converter 200 to preferentially perform a voltage control function, and enable the power converter 200 to output the reactive power. This can support the amplitude of the voltage of the electric power system 100, thereby supporting the voltage. The first voltage processing unit 221 may input the upper-limit voltage Uᵤₚ^{ref} to the first voltage control unit 223.

In an embodiment, when the amplitude |U| of the output voltage is less than the lower-limit voltage U_{dn}^{ref}, it indicates that the amplitude of the voltage of the electric power system 100 exceeds the normal voltage range. In this case, the amplitude of the voltage of the electric power system 100 operates at a low abnormal operating level, and the power converter 200 needs to additionally modify the reactive power output by the device, to support the voltage of the electric power system 100. The second voltage processing unit 222 may enable the power converter 200 to preferentially perform a voltage control function, and enable the power converter 200 to output the reactive power. This can support the amplitude of the voltage of the electric power system 100, thereby supporting the voltage. The second voltage processing unit 222 may input the lower-limit voltage U_{dn}^{ref} to the second voltage control unit 224.

In the embodiments, the power converter 200 may determine whether the amplitude |U| of the output voltage of the conversion circuit 210 exceeds a fluctuation range of a specified voltage. If the amplitude |U| of the output voltage of the conversion circuit 210 exceeds the fluctuation range of the specified voltage, it indicates that the voltage of the electric power system 100 is unstable and the power converter 200 needs to support the voltage of the electric power system 100. If the amplitude |U| of the output voltage of the conversion circuit 210 does not exceed the fluctuation range of the specified voltage, it indicates that the voltage of the electric power system 100 is stable, and the power converter 200 can normally output the original reactive power Q₀^{ref} to the electric power system 100.

The first voltage control unit 223 is configured to receive the upper-limit voltage Uᵤₚ^{ref} input by the first voltage processing unit 221. When the amplitude |U| of the output voltage is greater than the upper-limit voltage Uᵤₚ^{ref}, the first voltage control unit 223 may calculate an upper-limit reactive power Qᵤₚ^{ref} of the upper-limit voltage Uᵤₚ^{ref} based on the upper-limit voltage Uᵤₚ^{ref}.

In an embodiment, when receiving the upper-limit voltage Uᵤₚ^{ref}, the first voltage control unit 223 may convert the upper-limit voltage Uᵤₚ^{ref} into an upper-limit reactive power Q1 before amplitude limiting. The first voltage control unit 223 may limit an amplitude of the upper-limit voltage Uᵤₚ^{ref} based on parameters such as the upper-limit reactive power Q1 before amplitude limiting and the reactive power Q₀^{ref} input by the power converter 200 when the amplitude of the voltage of the electric power system 100 is normal, to obtain an upper-limit reactive power after amplitude limiting, which is denoted as the upper-limit reactive power Qᵤₚ^{ref} The first voltage control unit 223 may send the upper-limit reactive power Qᵤₚ^{ref} to the first power contention unit 225.

The second voltage control unit 224 is configured to receive the lower-limit voltage U_{dn}^{ref} input by the second voltage processing unit 222. When the amplitude |U| of the output voltage is less than the lower-limit voltage U_{dn}^{ref}, the second voltage control unit 224 may calculate the lower-limit reactive power Q_{dn}^{ref} based on the lower-limit voltage U_{dn}^{ref}.

In an embodiment, when receiving the lower-limit voltage U_{dn}^{ref}, the second voltage control unit 224 may convert the lower-limit voltage U_{dn}^{ref} into a lower-limit reactive power Q2 before amplitude limiting. The second voltage control unit 224 may limit an amplitude of the lower-limit voltage U_{dn}^{ref} based on parameters such as the lower-limit reactive power Q2 before amplitude limiting and the reactive power Q₀^{ref} input by the power converter 200 when the amplitude of the voltage of the electric power system 100 is normal, to obtain a lower-limit reactive power after amplitude limiting, which is denoted as the lower-limit reactive power Q_{dn}^{ref}. The second voltage control unit 224 may send the lower-limit reactive power Q_{dn}^{ref} to the second power contention unit 226.

In the embodiments, after receiving the upper-limit voltage Uᵤₚ^{ref} or the lower-limit voltage U_{dn}^{ref}, the power converter 200 may calculate, based on the upper-limit voltage Uᵤₚ^{ref} or the lower-limit voltage U_{dn}^{ref}, the reactive power that supports the stable voltage of the electric power system 100. In this way, the power converter 200 supports the voltage of the electric power system 100 by outputting the reactive power.

The first power contention unit 225 is configured to receive the upper-limit reactive power Qᵤₚ^{ref} sent by the first voltage control unit 223 and the original reactive power Q₀^{ref} stored by the controller 220. The first power contention unit 225 may enable the upper-limit reactive power Qᵤₚ^{ref} to contend with the original reactive power Q₀^{ref}.

In an embodiment, when the first power contention unit 225 receives the upper-limit reactive power Qᵤₚ^{ref}, the first power contention unit 225 selects to output a smaller reactive power between the upper-limit reactive power Qᵤₚ^{ref} and the original reactive power Q₀^{ref} as an upper-limit contention reactive power Qₘᵢₙ^{ref}. When the upper-limit reactive power Qᵤₚ^{ref} is greater than the original reactive power Q₀^{ref}, the first power contention unit 225 uses the original reactive power Q₀^{ref} as the upper-limit contention reactive power Qₘᵢₙ^{ref}, and sends the original reactive power Q₀^{ref} to the second power contention unit 226. In this case, the first power contention unit 225 may enable the power converter 200 to preferentially perform the reactive power control function. When the upper-limit reactive power Qᵤₚ^{ref} is less than the original reactive power Q₀^{ref}, the first power contention unit 225 uses the upper-limit reactive power Qᵤₚ^{ref} as the upper-limit contention reactive power Qₘᵢₙ^{ref}, and sends the upper-limit reactive power Qᵤₚ^{ref} to the second power contention unit 226. In this case, the first power contention unit 225 may enable the power converter 200 to preferentially perform the voltage control function.

In an embodiment, when the first power contention unit 225 does not receive the upper-limit reactive power Qᵤₚ^{ref}, the first power contention unit 225 sends the original reactive power Q₀^{ref} to the second power contention unit 226.

The second power contention unit 226 is configured to receive the lower-limit reactive power Q_{dn}^{ref} sent by the second voltage control unit 224 and the upper-limit contention reactive power Qₘᵢₙ^{ref} sent by the first power contention unit 225. The second power contention unit 226 may enable the lower-limit reactive power Q_{dn}^{ref} to contend with the upper-limit contention reactive power Qₘᵢₙ^{ref}.

In an embodiment, when the second power contention unit 226 receives the lower-limit reactive power Q_{dn}^{ref}, the second power contention unit 226 selects to output a larger reactive power between the lower-limit reactive power Q_{dn}^{ref} and the upper-limit contention reactive power Qₘᵢₙ^{ref} as the lower-limit contention reactive power Qₘₐₓ^{ref}. When the lower-limit reactive power Q_{dn}^{ref} is greater than the upper-limit contention reactive power Qₘᵢₙ^{ref}, the second power contention unit 226 uses the lower-limit reactive power Q_{dn}^{ref} an as the lower-limit contention reactive power Qₘₐₓ^{ref}, and sends the lower-limit reactive power Q_{dn}^{ref} to the power control unit 227. In this case, the second power contention unit 226 may enable the power converter 200 to preferentially perform the voltage control function. When the lower-limit reactive power Q_{dn}^{ref} is less than the upper-limit contention reactive power Qₘᵢₙ^{ref}, the second power contention unit 226 uses the upper-limit contention reactive power Qₘᵢₙ^{ref} as the lower-limit contention reactive power Qₘₐₓ^{ref}, and sends the upper-limit reactive power Qᵤₚ^{ref} or the original reactive power Q₀^{ref} to the power control unit 227. In this case, the second power contention unit 226 may enable the power converter 200 to preferentially perform the voltage control function or the reactive power control function.

In an embodiment, when the second power contention unit 226 does not receive the lower-limit reactive power Q_{dn}^{ref}, the second power contention unit 226 sends the upper-limit contention reactive power Qₘᵢₙ^{ref} to the power control unit 227.

On the contrary, the first power contention unit 225 may be connected to the second voltage control unit 224 for use. The second power contention unit 226 may be connected to the first voltage control unit 223 and the first power contention unit 225 for use. In this case, the first power contention unit 225 is configured to receive the lower-limit reactive power Q_{dn}^{ref} sent by the second voltage control unit 224 and the original reactive power Q₀^{ref} stored by the controller 220. The first power contention unit 225 may enable the lower-limit reactive power Q_{dn}^{ref} to contend with the original reactive power Q₀^{ref}.

In an embodiment, when the first power contention unit 225 receives the lower-limit reactive power Q_{dn}^{ref}, the first power contention unit 225 selects to output a larger reactive power between the lower-limit reactive power Q_{dn}^{ref} and the original reactive power Q₀^{ref} as the lower-limit contention reactive power Qₘₐₓ^{ref}. When the lower-limit reactive power Q₀^{ref} is greater than the original reactive power Q₀^{ref}, the first power contention unit 225 uses the lower-limit reactive power Q_{dn}^{ref} as the lower-limit contention reactive power Qₘₐₓ^{ref}, and sends the lower-limit reactive power Q_{dn}^{ref} to the second power contention unit 226. In this case, the first power contention unit 225 may enable the power converter 200 to preferentially perform the voltage control function. When the lower-limit reactive power Q_{dn}^{ref} is less than the original reactive power Q₀^{ref}, the first power contention unit 225 uses the original reactive power Q₀^{ref} as the lower-limit contention reactive power Qₘₐₓ^{ref}, and sends the original reactive power Q₀^{ref} to the second power contention unit 226. In this case, the first power contention unit 225 may enable the power converter 200 to preferentially perform the reactive power control function.

In an embodiment, when the first power contention unit 225 does not receive the lower-limit reactive power Q_{dn}^{ref}, the first power contention unit 225 sends the original reactive power Q₀^{ref} to the second power contention unit 226.

The second power contention unit 226 is configured to receive the upper-limit reactive power Qᵤₚ^{ref} sent by the first voltage control unit 223 and the lower-limit contention reactive power Qₘₐₓ^{ref} sent by the first power contention unit 225. The second power contention unit 226 may enable the upper-limit reactive power Qᵤₚ^{ref} to contend with the lower-limit contention reactive power Qₘₐₓ^{ref}.

In an embodiment, when the second power contention unit 226 receives the upper-limit reactive power Qᵤₚ^{ref}, the second power contention unit 226 selects to output a smaller reactive power between the upper-limit reactive power Qᵤₚ^{ref} and the lower-limit contention reactive power Qₘₐₓ^{ref} as the upper-limit contention reactive power Qₘᵢₙ^{ref}. When the upper-limit reactive power Qᵤₚ^{ref} is greater than the lower-limit contention reactive power Qₘₐₓ^{ref}, the second power contention unit 226 uses the lower-limit contention reactive power Qₘₐₓ^{ref} as the upper-limit contention reactive power Qₘᵢₙ^{ref}, and sends the lower-limit reactive power Q_{dn}^{ref} or the original reactive power Q₀^{ref} to the power control unit 227. In this case, the second power contention unit 226 may enable the power converter 200 to preferentially perform the voltage control function or the reactive power control function. When the upper-limit reactive power Qᵤₚ^{ref} is less than the lower-limit contention reactive power Qₘₐₓ^{ref}, the second power contention unit 226 uses the upper-limit reactive power Qᵤₚ^{ref} as the upper-limit contention reactive power Qₘᵢₙ^{ref}, and sends the upper-limit reactive power Qᵤₚ^{ref} to the power control unit 227. In this case, the second power contention unit 226 may enable the power converter 200 to preferentially perform the voltage control function.

In an embodiment, when the second power contention unit 226 does not receive the upper-limit reactive power Qᵤₚ^{ref}, the second power contention unit 226 sends the lower-limit contention reactive power Qₘₐₓ^{ref} to the power control unit 227.

In the embodiments, after receiving the upper-limit reactive power Qᵤₚ^{ref} or the lower-limit reactive power Q_{dn}^{ref}, the power converter 200 enables the upper-limit reactive power Qᵤₚ^{ref} or the lower-limit reactive power Q_{dn}^{ref} to contend with the original reactive power Q₀^{ref}, and outputs a contention reactive power. The power converter 200 seamlessly switches between a voltage control mode and a reactive power control mode through contention, without affecting the electric power system 100.

The power control unit 227 is configured to receive the upper-limit reactive power Qᵤₚ^{ref} of the first power contention unit 225, the lower-limit reactive power Q_{dn}^{ref} of the second power contention unit 226, and the original reactive power Q₀^{ref} stored by the controller 220. The power control unit 227 may calculate an amplitude |V| of an inner potential based on the upper-limit reactive power Qᵤₚ^{ref}, the lower-limit reactive power Q_{dn}^{ref}, or the original reactive power Q₀^{ref}.

In an embodiment, when the power control unit 227 receives the upper-limit reactive power Qᵤₚ^{ref}, the power control unit 227 may calculate the amplitude of the inner potential based on the upper-limit reactive power Qᵤₚ^{ref}. The controller 220 controls a pulse width modulation (PWM) signal based on the amplitude of the inner potential, a phase of the inner potential, and a frequency of the inner potential, to control the voltage at the output end of the conversion circuit 210. The controller 220 outputs the reactive power to the electric power system 100, so that the amplitude of the voltage of the electric power system 100 can be reduced, and a fluctuation amplitude of the voltage of the electric power system 100 can be reduced.

In an embodiment, when the power control unit 227 receives the lower-limit reactive power Q_{dn}^{ref}, the power control unit 227 may calculate the amplitude of the inner potential based on the lower-limit reactive power Q_{dn}^{ref}. The controller 220 controls a PWM signal based on the amplitude of the inner potential, a phase of the inner potential, and a frequency of the inner potential, to control the voltage at the output end of the conversion circuit 210. The controller 220 outputs the reactive power to the electric power system 100, so that the amplitude of the voltage of the electric power system 100 can be increased, and a fluctuation amplitude of the voltage of the electric power system 100 can be reduced.

In an embodiment, when the power control unit 227 receives the original reactive power Q₀^{ref}, the power control unit 227 may calculate the amplitude of the inner potential based on the original reactive power Q₀^{ref}. The controller 220 controls a PWM signal based on the amplitude of the inner potential, a phase of the inner potential, and a frequency of the inner potential, to control the voltage at the output end of the conversion circuit 210, so that the controller 220 normally outputs the reactive power to the electric power system 100.

In this embodiment, the power converter 200 receives the amplitude of the output voltage at the output end of the conversion circuit 210, and determines whether the amplitude of the voltage of the electric power system is abnormal. When determining that the amplitude of the voltage of the electric power system 100 is abnormal, the power converter 200 may generate the reactive power based on a preset voltage range, and output the reactive power to the conversion circuit 210, to quickly support the voltage of the electric power system 100, and maximum the support on the voltage of the electric power system 100. In this way, the power converter 200 can operate within the normal voltage range. The power converter 200 seamlessly switches between a voltage control mode and a reactive power control mode through contention, without affecting the electric power system 100.

In the embodiments, when the amplitude of the voltage of the electric power system 100 is restored from a large fluctuation to the normal voltage range, to prevent a few power converters 200 from being in the voltage control mode for long time, the power converters 200 freeze the contention reactive power after the electric power system 100 is restored to the normal range, and generate new reactive powers based on the original reactive power or according to a preset function to transition to a normal operating state.

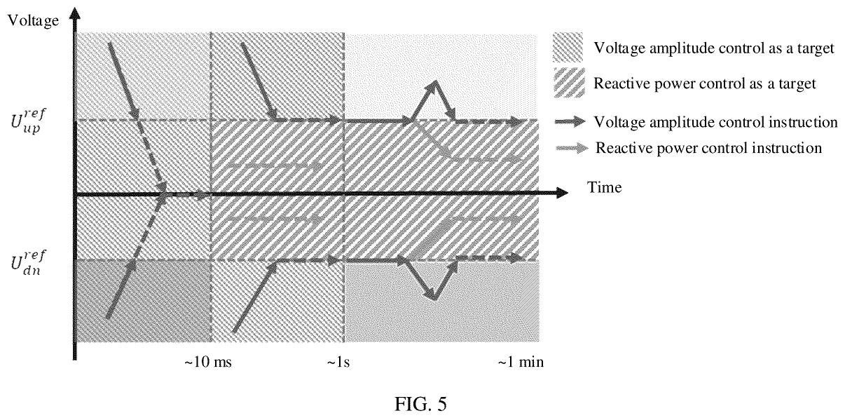

As shown in FIG. 5, the controller 220 receives the amplitude |U| of the output voltage at the output end of the conversion circuit 210 in real time. If the controller 220 determines that the amplitude |U| of the output voltage is between the upper-limit voltage Uᵤₚ^{ref} and the lower-limit voltage U_{dn}^{ref}, it indicates that the voltage of the electric power system 100 is supported, and the electric power system 100 can maintain stable operation. In an embodiment, when the controller 220 determines that time in which the amplitude |U| of the output voltage is stable at the upper-limit voltage Uᵤₚ^{ref} or the lower-limit voltage U^{ref} exceeds first specified time, the controller 220 may freeze an output contention reactive power Qe, so that the conversion circuit 210 keeps outputting the contention reactive power Qe. In this way, the electric power system 100 maintains stable operation. In addition, the controller 220 can avoid a cross current between a plurality of power converters 200 due to voltage control.

In an embodiment, when the controller 220 determines that time in which the amplitude |U| of the output voltage is stable at the upper-limit voltage Uᵤₚ^{ref} or the lower-limit voltage U_{dn}^{ref} exceeds second specified time, the controller 220 may output the original reactive power Q₀^{ref} or change, according to a preset function f₂(t, Q), a contention reactive power Qe output by the controller 220. The controller 220 is enabled to output the original reactive power Q₀^{ref} or a new reactive power Q₁^{ref}. After time in which the controller 220 outputs the voltage to support the electric power system 100 exceeds the second specified time, the controller 220 does not enter the voltage control mode, and outputs the original reactive power Q₀^{ref} or the reactive power Q₁^{ref} generated according to the preset function. This can avoid that a reactive power requirement of the electric power system 100 is borne by the few power converters 200, resulting in a decrease in reliability of the power converters 200.

In an embodiment, when the controller 220 determines that the amplitude |U| of the output voltage is greater than the upper-limit voltage Uᵤₚ^{ref} again or less than the lower-limit voltage U_{dn}^{ref} again within second specified time, the controller 220 performs the technical solutions described in FIG. 3 again.

In the embodiments, when great disturbance occurs in the voltage of the electric power system 100, the output current at the output end of the power converter 200 may be saturated. Consequently, control of the power converter 200 is unstable. Within about 10 ms after the disturbance occurs in the electric power system 100, the power converter 200 inputs a dynamic virtual impedance, to avoid the saturation of the power converter 200.

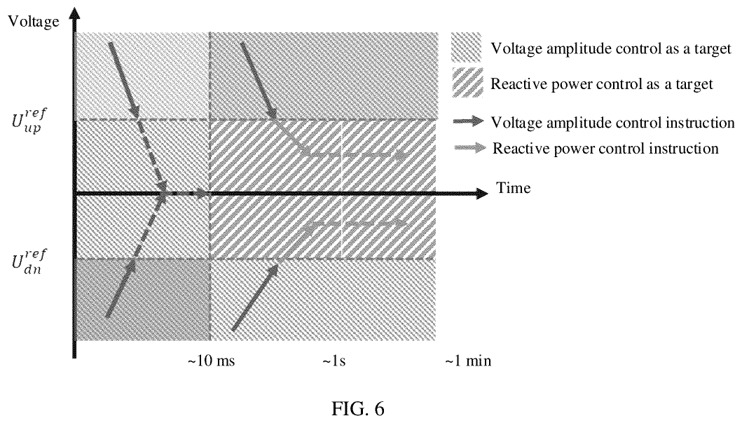

In an embodiment, as shown in FIG. 6, when an output current at the output end of the conversion circuit 210 of the power converter 200 exceeds a specified threshold, a virtual impedance X and a virtual resistor R may be obtained according to a preset function, an additional voltage instruction signal is calculated by using the virtual impedance X, the additional voltage instruction signal is input to a voltage control loop, and the virtual impedance and the virtual resistance may be changed in a transient state process. The virtual impedance and the virtual resistance increase as an amplitude of the output current increases, to ensure that voltage control is not saturated. In another embodiment, the preset function may be f₁(I, X, R), where f₁(I, X, R) is a preset function between an amplitude of a current, and the virtual impedance X and the virtual impedance R.

When the output current at the output end of the conversion circuit 210 of the power converter 200 decreases to be less than the specified threshold, a dynamic virtual impedance corresponding to the preset function is 0 or less than the specified threshold, and the controller 220 performs the technical solutions described in FIG. 3 again. When the dynamic virtual impedance corresponding to the preset function is a constant value, the controller 220 performs the technical solutions described in FIG. 3 again.

It should be noted that each unit of the controller 220 transmits reactive powers such as the original reactive power Q₀^{ref}, the upper-limit reactive power Qᵤₚ^{ref}, and the lower-limit reactive power Q_{dn}^{ref} in a form of an instruction. For example, an original reactive power instruction is an instruction carrying the original reactive power Q₀^{ref}. The amplitude of the inner potential is transmitted in the form of an instruction.

In the embodiments, the controller 220 controls the voltage at the output end of the conversion circuit 210 based on the amplitude of the inner potential, a phase of the output voltage at the output end of the conversion circuit 210, and a frequency of the output voltage at the output end of the conversion circuit 210, so that the conversion circuit outputs the reactive power. In an embodiment, the controller 220 further includes a first coordinate conversion unit, a voltage control unit, a current control unit, a second coordinate conversion unit, and a modulation unit. The first coordinate conversion unit receives parameters of the inner potential such as the amplitude of the inner potential, the frequency of the inner potential, and the phase of the inner potential, and converts the inner potential from a polar coordinate system into a rectangular coordinate system, to obtain an inner potential U_{dq}^{ref}. After receiving the inner potential U_{dq}^{ref}, the voltage control unit calculates a current I_{dq}^{ref}. After receiving the current I_{dq}^{ref} the current control unit calculates a modulation voltage E_{dq}^{ref} of a rotating coordinate system. The second coordinate conversion unit converts the modulation voltage E_{dq}^{ref} from the rotating coordinate system to a stationary coordinate system, to obtain a modulation voltage E_{abc}^{ref} of the stationary coordinate system. After obtaining the modulation voltage E_{abc}^{ref} of the stationary coordinate system, the modulation unit generates a corresponding PWM signal. The controller 220 inputs the PWM signal to the conversion circuit 210, so that a power electronic component inside the conversion circuit 210 operates, to adjust the amplitude of the output voltage at the output end of the conversion circuit 210.

In another embodiment, the controller 220 further includes a first coordinate conversion unit, a second coordinate conversion unit, and a modulation unit. The first coordinate conversion unit receives parameters of the inner potential such as the amplitude of the inner potential, the frequency of the inner potential, and the phase of the inner potential, and converts the inner potential from a polar coordinate system into a rectangular coordinate system, to obtain a modulation voltage E_{dq}^{ref}. The second coordinate conversion unit converts the modulation voltage E_{dq}^{ref} from a rotating coordinate system to a stationary coordinate system, to obtain a modulation voltage E_{abc}^{ref} of the stationary coordinate system. After obtaining the modulation voltage E_{abc}^{ref} of the stationary coordinate system, the modulation unit generates a corresponding PWM signal. The controller 220 inputs the PWM signal to the conversion circuit 210, so that a power electronic component inside the conversion circuit 210 operates, to adjust the amplitude of the output voltage at the output end of the conversion circuit 210.

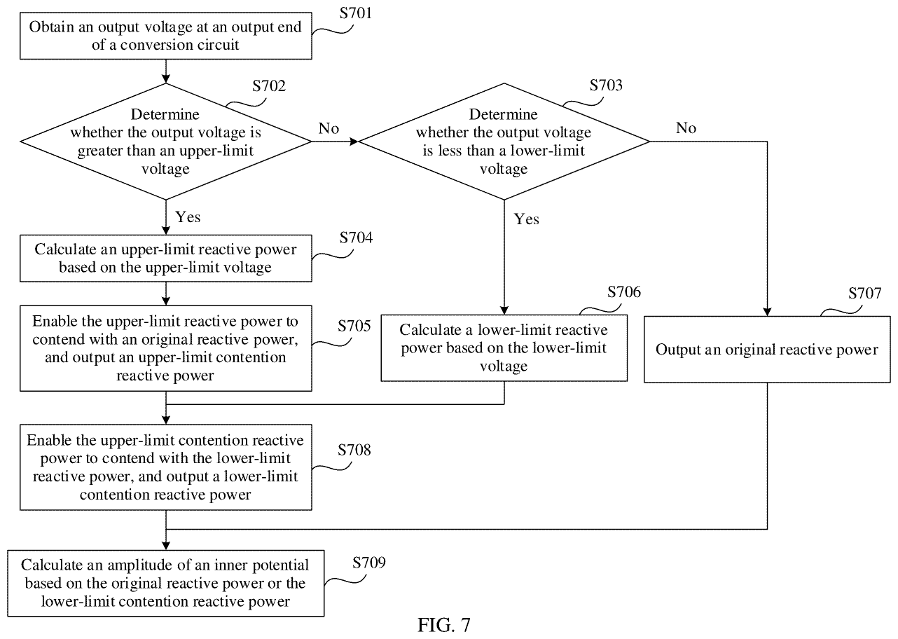

FIG. 7 is a schematic flowchart of a grid-forming control method for a power converter according to an embodiment. As shown in FIG. 7, the method is performed by the controller 220 inside the power converter 200. A specific implementation process is as follows.

Step S701: The controller 220 obtains the amplitude |U| of the output voltage at the output end of the conversion circuit 210.

The controller 220 obtains the amplitude |U| of the output voltage at the output end of the conversion circuit 210. The amplitude |U| of the output voltage is the amplitude of the voltage of the electric power system 100. By obtaining the amplitude of the voltage of the electric power system 100, the controller 220 can detect an amplitude fluctuation of the voltage of the electric power system 100, thereby implementing control of the stable operation of the electric power system 100.

Step S702: The controller 220 determines whether the amplitude |U| of the output voltage is greater than the upper-limit voltage Uᵤₚ^{ref}. When the amplitude |U| of the output voltage is not greater than the upper-limit voltage Uᵤₚ^{ref}, step S703 is performed. When the amplitude |U| of the output voltage is greater than the upper-limit voltage Uᵤₚ^{ref}, step S704 is performed.

Step S703: The controller 220 determines whether the amplitude |U| of the output voltage is less than the lower-limit voltage U_{dn}^{ref}. When the amplitude |U| of the output voltage is less than the lower-limit voltage U_{dn}^{ref}, step S706 is performed. When the amplitude |U| of the output voltage is not less than the lower-limit voltage U_{dn}^{ref}, step S707 is performed.

After receiving the amplitude |U| of the output voltage of the conversion circuit 210, the controller 220 determines whether the amplitude |U| of the output voltage is greater than the upper-limit voltage Uᵤₚ^{ref}. In an embodiment, when the amplitude |U| of the output voltage is greater than the upper-limit voltage Uᵤₚ^{ref}, it indicates that the amplitude of the voltage of the electric power system 100 exceeds the normal voltage range. In this case, the amplitude of the voltage of the electric power system 100 operates at the high abnormal operating level, and the power converter 200 needs to additionally modify the reactive power output by the device, to support the voltage of the electric power system 100. The controller 220 may enable the power converter 200 to preferentially perform the voltage control function, and enable the power converter 200 to output the reactive power. This can support the amplitude of the voltage of the electric power system 100, thereby supporting the voltage.

When determining that the amplitude |U| of the output voltage is not greater than the upper-limit voltage Uᵤₚ^{ref}, the controller 220 determines whether the amplitude |U| of the output voltage is greater than the lower-limit voltage U_{dn}^{ref}. In an embodiment, when the amplitude |U| of the output voltage is less than the lower-limit voltage U_{dn}^{ref}, it indicates that the amplitude of the voltage of the electric power system 100 exceeds the normal voltage range. In this case, the amplitude of the voltage of the electric power system 100 operates at the low abnormal operating level, and the power converter 200 needs to additionally modify the reactive power output by the device, to support the voltage of the electric power system 100. The controller 220 may enable the power converter 200 to preferentially perform the voltage control function, and enable the power converter 200 to output the reactive power. This can support the amplitude of the voltage of the electric power system 100, thereby supporting the voltage.

In an embodiment, when the amplitude |U| of the output voltage is not greater than the upper-limit voltage Uᵤₚ^{ref} and is not less than the lower-limit voltage U_{dn}^{ref}, it indicates that an amplitude of the voltage of the electric power system 100 is within the normal voltage range. In this case, the voltage fluctuation of the electric power system 100 is small, and the power converter 200 may not need to additionally modify the reactive power output by the device, and preferentially perform the reactive power control function. The controller 220 may enable the power converter 200 to send the original reactive power Q₀^{ref} to the power control unit 227.

Step S704: The controller 220 calculates the upper-limit reactive power Qᵤₚ^{ref} based on the upper-limit voltage Uᵤₚ^{ref}.

When receiving the upper-limit voltage Uᵤₚ^{ref}, the controller 220 may convert the upper-limit voltage Uᵤₚ^{ref} into the upper-limit reactive power Q1 before amplitude limiting. The controller 220 may limit the amplitude of the upper-limit voltage Uᵤₚ^{ref} based on the parameters such as the upper-limit reactive power Q1 before amplitude limiting and the reactive power Q₀^{ref} input by the power converter 200 when the amplitude of the voltage of the electric power system 100 is normal, to obtain the upper-limit reactive power after amplitude limiting, which is denoted as the upper-limit reactive power Qᵤₚ^{ref}.

Step S705: The controller 220 enables the upper-limit reactive power Qᵤₚ^{ref} to contend with the original reactive power Q₀^{ref}, and outputs the upper-limit contention reactive power Qₘᵢₙ^{ref}.

When the controller 220 receives the upper-limit reactive power Qᵤₚ^{ref}, the controller 220 selects to output the smaller reactive power between the upper-limit reactive power Qᵤₚ^{ref} and the original reactive power Q₀^{ref} as the upper-limit contention reactive power Qₘᵢₙ^{ref}. In an embodiment, when the upper-limit reactive power Q_{UP}^{ref} is greater than the original reactive power Q₀^{ref}, the controller 220 uses the original reactive power Q₀^{ref} as the upper-limit contention reactive power Qₘᵢₙ^{ref}, so that the power converter 200 can preferentially perform the reactive power control function.

In an embodiment, when the upper-limit reactive power Qᵤₚ^{ref} is less than the original reactive power Q₀^{ref}, the controller 220 uses the upper-limit reactive power Qᵤₚ^{ref} as the upper-limit contention reactive power Qₘᵢₙ^{ref}, so that the power converter 200 can preferentially perform the voltage control function.

In an embodiment, when the controller 220 does not receive the upper-limit reactive power Qᵤₚ^{ref}, the controller 220 uses the original reactive power Q₀^{ref} as the upper-limit contention reactive power Qₘᵢₙ^{ref}, so that the power converter 200 can preferentially perform the voltage control function. Step S706: The controller 220 calculates the lower-limit reactive power Q_{dn}^{ref} based on the lower-limit voltage U_{dn}^{ref}.

When receiving the lower-limit voltage U_{dn}^{ref}, the controller 220 may convert the lower-limit voltage U_{dn}^{ref} into the lower-limit reactive power Q2 before amplitude limiting. The controller 220 may limit the amplitude of the lower-limit voltage U_{dn}^{ref} based on the parameters such as the lower-limit reactive power Q2 before amplitude limiting and the reactive power Q₀^{ref} input by the power converter 200 when the amplitude of the voltage of the electric power system 100 is normal, to obtain the lower-limit reactive power after amplitude limiting, which is denoted as the lower-limit reactive power Q_{dn}^{ref}.

Step S707: The controller 220 outputs the original reactive power Q₀^{ref}.

Step S708: The controller 220 enables the lower-limit reactive power Q_{dn}^{ref} to contend with the upper-limit contention reactive power Qₘᵢₙ^{ref}, and outputs the lower-limit contention reactive power Qₘₐₓ^{ref}.

When the controller 220 receives the lower-limit reactive power Q_{dn}^{ref} and the upper-limit contention reactive power Qₘᵢₙ^{ref}, the controller 220 selects to output a larger reactive power between the lower-limit reactive power Q_{dn}^{ref} and the upper-limit contention reactive power Qₘᵢₙ^{ref} as the lower-limit contention reactive power Qₘₐₓ^{ref}. In an embodiment, when the lower-limit reactive power Q_{dn}^{ref} is greater than the upper-limit contention reactive power Qₘᵢₙ^{ref}, the controller 220 uses the lower-limit reactive power Q_{dn}^{ref} as the lower-limit contention reactive power Qₘₐₓ^{ref}, so that the power converter 200 can preferentially perform the voltage control function.

In an embodiment, when the lower-limit reactive power Q_{dn}^{ref} is less than the upper-limit contention reactive power Qₘᵢₙ^{ref}, the controller 220 uses the upper-limit contention reactive power Qₘᵢₙ^{ref} as the lower-limit contention reactive power Qₘₐₓ^{ref}, so that the power converter 200 can preferentially perform the voltage control function or the reactive power control function.

In an embodiment, when the controller 220 does not receive the lower-limit reactive power Q_{dn}^{ref}, the controller 220 uses the upper-limit contention reactive power Qₘᵢₙ^{ref} as the lower-limit contention reactive power Qₘₐₓ^{ref}, so that the power converter 200 can preferentially perform the voltage control function or the reactive power control function.

Step S709: The controller 220 may calculate the amplitude |V| of the inner potential based on the original reactive power Q₀^{ref} or the lower-limit contention reactive power Qₘₐₓ^{ref}.

When the controller 220 receives the upper-limit reactive power Qᵤₚ^{ref}, the controller 220 may calculate the amplitude of the inner potential based on the upper-limit reactive power Qᵤₚ^{ref}. The controller 220 controls the PWM signal based on the amplitude of the inner potential, the phase of the inner potential, and the frequency of the inner potential, to control the voltage at the output end of the conversion circuit 210. The controller 220 outputs the reactive power to the electric power system 100, so that the amplitude of the voltage of the electric power system 100 can be reduced, and the fluctuation amplitude of the voltage of the electric power system 100 can be reduced.

When the controller 220 receives the lower-limit reactive power Q_{dn}^{ref}, the controller 220 may calculate the amplitude of the inner potential based on the lower-limit reactive power Q_{dn}^{ref}. The controller 220 controls the PWM signal based on the amplitude of the inner potential, the phase of the inner potential, and the frequency of the inner potential, to control the voltage at the output end of the conversion circuit 210. The controller 220 outputs the reactive power to the electric power system 100, so that the amplitude of the voltage of the electric power system 100 can be increased, and the fluctuation amplitude of the voltage of the electric power system 100 can be reduced.

When the controller 220 receives the original reactive power Q₀^{ref}, the controller 220 may calculate the amplitude of the inner potential based on the original reactive power Q₀^{ref}. The controller 220 controls the PWM signal based on the amplitude of the inner potential, the phase of the inner potential, and the frequency of the inner potential, to control the voltage at the output end of the conversion circuit 210, so that the controller 220 normally outputs the reactive power to the electric power system 100.

When the controller 220 performs step S705 to step S708, the controller 220 preferentially enables the upper-limit reactive power Qᵤₚ^{ref} to contend with the original reactive power Q₀^{ref}, and then enables the upper-limit contention reactive power Qₘᵢₙ^{ref} to contend with the lower-limit reactive power Q_{dn}^{ref} to obtain the lower-limit contention reactive power Qₘₐₓ^{ref}. Optionally, the controller 220 may preferentially enable the lower-limit reactive power Q_{dn}^{ref} to contend with the original reactive power Q₀^{ref}, and then enable the lower-limit contention reactive power ₘₐₓ^{ref} to contend with the upper-limit reactive power Qᵤₚ^{ref} to obtain the upper-limit contention reactive power Qₘᵢₙ^{ref}. Details are as follows:

The controller 220 receives the lower-limit reactive power Q_{dn}^{ref}, and enables the lower-limit reactive power Q_{dn}^{ref} to contend with the original reactive power Q₀^{ref}. The controller 220 selects to output the larger reactive power between the lower-limit reactive power Q_{dn}^{ref} and the original reactive power Q₀^{ref} as the lower-limit contention reactive power Qₘₐₓ^{ref} In an embodiment, when the lower-limit reactive power Q_{dn}^{ref} is greater than the original reactive power Q₀^{ref}, the controller 220 uses the lower-limit reactive power Q_{dn}^{ref} as the lower-limit contention reactive power Qₘₐₓ^{ref}, so that the power converter 200 can preferentially perform the voltage control function.

In an embodiment, when the lower-limit reactive power Q_{dn}^{ref} is less than the original reactive power Q₀^{ref}, the controller 220 uses the original reactive power Q₀^{ref} as the lower-limit contention reactive power Qₘₐₓ^{ref}, so that the power converter 200 can preferentially perform the reactive power control function.

In an embodiment, when the controller 220 does not receive the lower-limit reactive power Q_{dn}^{ref}, the controller 220 uses the original reactive power Q₀^{ref} as the lower-limit contention reactive power Qₘₐₓ^{ref}, so that the power converter 200 can preferentially perform the reactive power control function.

When receiving the upper-limit reactive power Qᵤₚ^{ref} and the lower-limit contention reactive power Qₘₐₓ^{ref}, the controller 220 enables the upper-limit reactive power Qᵤₚ^{ref} to contend with the lower-limit contention reactive power Qₘₐₓ^{ref}. The controller 220 selects to output the smaller reactive power between the upper-limit reactive power Qᵤₚ^{ref} and the lower-limit contention reactive power Qₘₐₓ^{ref} as the upper-limit contention reactive power Qₘᵢₙ^{ref}.

In an embodiment, when the upper-limit reactive power Qᵤₚ^{ref} is greater than the lower-limit contention reactive power Qₘₐₓ^{ref}, the controller 220 uses the lower-limit contention reactive power Qₘₐₓ^{ref} as the upper-limit contention reactive power Qₘᵢₙ^{ref}, so that the power converter 200 can preferentially perform the voltage control function or the reactive power control function.

In an embodiment, when the upper-limit reactive power Qᵤₚ^{ref} is less than the lower-limit contention reactive power Qₘₐₓ^{ref}, the controller 220 uses the upper-limit reactive power Qᵤₚ^{ref} as the upper-limit contention reactive power Qₘᵢₙ^{ref}, so that the power converter 200 can preferentially perform the voltage control function.

In an embodiment, when the controller 220 does not receive the upper-limit reactive power Qᵤₚ^{ref}, the controller 220 uses the upper-limit reactive power Qᵤₚ^{ref} as the upper-limit contention reactive power Qₘᵢₙ^{ref}, so that the power converter 200 can preferentially perform the voltage control function.

In this embodiment of this application, when the voltage of the electric power system fluctuates, the controller can quickly support the voltage of the electric power system, and can maximally support the voltage of the electric power system, so that the power converter can operate within the normal voltage range. Because voltage control and reactive power control are output through contention, the power converter seamlessly switches between the voltage control mode and the reactive power control mode, without affecting the electric power system.

An embodiment further provides a computer program product including instructions. The computer program product may be a software or program product that includes instructions and that can run on a computing device or be stored in any usable medium. When the computer program product is run on at least one computing device, the at least one computing device is enabled to perform the grid-forming control method for the power converter.

An embodiment further provides a non-transitory computer-readable storage medium. The non-transitory computer-readable storage medium may be any usable medium that can be stored by a computing device, or a data storage device like a data center, including one or more usable media. The usable medium may be a magnetic medium (for example, a floppy disk, a hard disk drive, or a magnetic tape), an optical medium (for example, a DVD), a semiconductor medium (for example, a solid state drive), or the like. The non-transitory computer-readable storage medium includes instructions, and the instructions instruct a computing device to perform the grid-forming control method for the power converter.

It should be noted that the foregoing embodiments are merely intended for describing solutions, but should not be considered as limiting. Although described in detail with reference to the foregoing embodiments, persons of ordinary skill in the art should understand that they may still make modifications to the solutions described in the foregoing embodiments or make equivalent replacements to some features thereof, without departing from the scope of the solutions of the embodiments.

1. A method for a power converter, used in the power converter, wherein the power converter comprises a conversion circuit, an input end of the conversion circuit is configured to connect to a direct current source, an output end of the conversion circuit is configured to connect to an electric power system, and the method comprises:
detecting an output voltage at the output end of the conversion circuit; and
when an amplitude of the output voltage is greater than an upper-limit voltage of a specified voltage range or less than a lower-limit voltage of the specified voltage range, controlling the conversion circuit to output a first reactive power, wherein the upper-limit voltage is a maximum voltage value within the specified voltage range, the lower-limit voltage is a minimum voltage value within the specified voltage range, and the first reactive power is a reactive power that enables the amplitude of the output voltage at the output end of the conversion circuit to be within the specified voltage range.

2. The method according to claim 1, wherein,
when the amplitude of the output voltage is greater than the upper-limit voltage of the specified voltage range or less than the lower-limit voltage of the specified voltage range, controlling the conversion circuit to output the first reactive power further comprises:
calculating an upper-limit reactive power based on the upper-limit voltage;
calculating a lower-limit reactive power based on the lower-limit voltage;
selecting a contention reactive power based on a relationship between the upper-limit reactive power, the lower-limit reactive power, and an upper-level scheduled reactive power, wherein the contention reactive power is one of the upper-limit reactive power, the lower-limit reactive power, and the upper-level scheduled reactive power; and
controlling, based on the contention reactive power, the conversion circuit to output the first reactive power.

3. The method according to claim 2, wherein calculating the upper-limit reactive power based on the upper-limit voltage further comprises:
when the amplitude of the output voltage is greater than the upper-limit voltage, calculating a second reactive power based on the upper-limit voltage; and
limiting an amplitude of a voltage corresponding to the second reactive power, and calculating the upper-limit reactive power.

4. The method according to claim 2, wherein calculating the lower-limit reactive power based on the lower-limit voltage further comprises:
when the amplitude of the output voltage is less than the lower-limit voltage,
calculating a third reactive power based on the lower-limit voltage;
limiting an amplitude of a voltage corresponding to the third reactive power; and
calculating the lower-limit reactive power.

5. The method according to claim 2, wherein selecting the contention reactive power based on the relationship between the upper-limit reactive power, the lower-limit reactive power, and the upper-level scheduled reactive power further comprises:
selecting a smaller reactive power from the upper-limit reactive power and the upper-level scheduled reactive power as an upper-limit contention reactive power; and
selecting a larger reactive power from the upper-limit contention reactive power and the lower-limit reactive power as the contention reactive power.

6. The method according to claim 2, wherein selecting the contention reactive power based on the relationship between the upper-limit reactive power, the lower-limit reactive power, and the upper-level scheduled reactive power further comprises:
selecting a larger reactive power from the lower-limit reactive power and the upper-level scheduled reactive power as a lower-limit contention reactive power; and
selecting a smaller reactive power from the lower-limit contention reactive power and the upper-limit reactive power as the contention reactive power.

7. The method according to claim 1, further comprising:
when the amplitude of the output voltage is within the specified voltage range, controlling the conversion circuit to output the upper-level scheduled reactive power.

8. The method according to claim 1, further comprising:
when a time in which the amplitude of the output voltage of the conversion circuit is at the upper-limit voltage or the lower-limit voltage exceeds first specified time, maintaining a value of the contention reactive power unchanged.

9. The method according to claim 8, further comprising:
when a time in which the amplitude of the output voltage of the conversion circuit is at the upper-limit voltage or the lower-limit voltage exceeds second specified time,
controlling the conversion circuit to output the upper-level scheduled reactive power, or
controlling the conversion circuit to output another reactive power according to a preset function, wherein the second specified time is greater than the first specified time.

10. The method according to claim 2, wherein before calculating the upper-limit reactive power based on the upper-limit voltage, and calculating the lower-limit reactive power based on the lower-limit voltage, the method further comprises:
detecting an output current at the output end of the conversion circuit; and
when the output current is greater than a specified current threshold, obtaining a dynamic virtual impedance and a dynamic virtual impedance according to a preset function.

11. The method according to claim 2, wherein controlling, based on the contention reactive power, the conversion circuit to output the first reactive power further comprises:
controlling an amplitude of an inner potential based on the contention reactive power, wherein the amplitude of the inner potential is an amplitude of a voltage of an inner potential vector provided by the power converter to support a voltage of the electric power system; and
controlling a voltage of the inner potential of the power converter based on the amplitude of the inner potential, a phase of the inner potential, and a frequency of the inner potential, to enable the conversion circuit to output the first reactive power.

12. A power converter, comprising a conversion circuit and a controller, wherein an input end of the conversion circuit is configured to connect a direct current source, and an output end of the conversion circuit is configured to connect an electric power system;
the power converter is configured to convert direct current electric energy into alternating current electric energy under control of the controller; and
the controller is configured to:
obtain an output voltage at the output end of the conversion circuit; and
when an amplitude of the output voltage is greater than an upper-limit voltage of a specified voltage range or less than a lower-limit voltage of the specified voltage range, control the conversion circuit to output a first reactive power, wherein the upper-limit voltage is a maximum voltage value within the specified voltage range, the lower-limit voltage is a minimum voltage value within the specified voltage range, and the first reactive power is a reactive power that enables the amplitude of the output voltage at the output end of the conversion circuit to be within the specified voltage range.

13. The power converter according to claim 12, wherein the controller is further configured to:
calculate an upper-limit reactive power based on the upper-limit voltage;
calculate a lower-limit reactive power based on the lower-limit voltage;
select a contention reactive power based on a relationship between the upper-limit reactive power, the lower-limit reactive power, and an upper-level scheduled reactive power, wherein the contention reactive power is one of the upper-limit reactive power, the lower-limit reactive power, and the upper-level scheduled reactive power; and
control, based on the contention reactive power, the conversion circuit to output the first reactive power.

14. The power converter according to claim 13, wherein the controller is further configured to:
when the amplitude of the output voltage is greater than the upper-limit voltage, calculate a second reactive power based on the upper-limit voltage;
limit an amplitude of a voltage corresponding to the second reactive power; and
calculate the upper-limit reactive power.

15. The power converter according to claim 13, wherein the controller is further configured to:
when the amplitude of the output voltage is less than the lower-limit voltage,
calculate a third reactive power based on the lower-limit voltage;
limit an amplitude of a voltage corresponding to the third reactive power; and
calculate the lower-limit reactive power.

16. The power converter according to claim 13, wherein the controller is further configured to:
select a smaller reactive power from the upper-limit reactive power and the upper-level scheduled reactive power as an upper-limit contention reactive power; and
select a larger reactive power from the upper-limit contention reactive power and the lower-limit reactive power as the contention reactive power.

17. The power converter according to claim 13, wherein the controller is further configured to:
select a larger reactive power from the lower-limit reactive power and the upper-level scheduled reactive power as a lower-limit contention reactive power; and
select a smaller reactive power from the lower-limit contention reactive power and the upper-limit reactive power as the contention reactive power.

18. The power converter according to claim 12, wherein the controller is further configured to:
when the amplitude of the output voltage is within the specified voltage range,
control the conversion circuit to output the upper-level scheduled reactive power.

19. The power converter according to claim 12, wherein the controller is further configured to:
when a time in which the amplitude of the output voltage of the conversion circuit is at the upper-limit voltage or the lower-limit voltage exceeds first specified time,
maintain a value of the contention reactive power unchanged.

20. The power converter according to claim 19, wherein the controller is further configured to:
when a time in which the amplitude of the output voltage of the conversion circuit is at the upper-limit voltage or the lower-limit voltage exceeds second specified time,
control the conversion circuit to output the upper-level scheduled reactive power, or
control the conversion circuit to output another reactive power according to a preset function, wherein the second specified time is greater than the first specified time.
